(19) United States
(12) Patent Application Publication
(10) Pub. No.: US 2004/0025277 A1
(43) Pub. Date: Feb. 12, 2004

(54) Smoother with a friction sleeve on handle

(76) Inventor: Timmy Chen, East District (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,378

(22) Filed: Aug. 12, 2002

(51) Int. Cl. B05C 17/10

(52) U.S. Cl. 15/235.4; 15/143.1

(57) ABSTRACT

A smoother includes a plate with a neck connected to an end of the plate and a handle is connected to the neck. A friction sleeve is mounted to the neck so that the user may snap the friction sleeve by his or her index finger and thumb to operate the smoother. The friction sleeve can be added to the existed smoother without too much amendment.

### FIELD OF THE INVENTION

The present invention relates to a smoother that includes a plate and an L-shaped neck with a handle connected to the neck. A friction sleeve is mounted to the neck so that the user can hold the neck firmly without slippery.

### BACKGROUND OF THE INVENTION

A conventional smoother for smoothing a surface of construction object such as a concrete surface or patch surface is shown in FIGS. 9 and 10, and generally includes a plate 10 and an L-shaped neck 20 is connected to the plate 10. A handle 30 is fixed to the neck so that the user may hold the handle 30 to smooth the surface of an object. In order to control the plate 10, the user usually uses his or her thumb and index finger to clamp the neck 20. Nevertheless, the neck 20 generally has a smooth and slippery outer surface and the user's hand is attached with water during working so that it is inconvenient to firmly clamp the neck 20 and the user has to use more effort to make sure that the fingers will not slip off from the neck 20.

The present invention intends to provide a friction sleeve that is mounted to the neck of the smoother so that the user can conveniently clamp the neck and operate the smoother.

### SUMMARY OF THE INVENTION

In accordance with one aspect of the present invention, there is provided a smoother which comprises a plate with a neck connected to an end of the plate and a handle is connected to the neck. A friction sleeve is mounted to the neck.

The primary object of the present invention is to provide a smoother that includes a friction sleeve mounted to the neck of the smoother so that the user can hold the smoother without slippery.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the smoother of the present invention;

FIG. 2 is a perspective view to show the smoother is held by a hand;

FIG. 3 is a side view to show the smoother is held by a hand;

FIG. 4 is a top view to show the smoother is held by a hand;

FIG. 5 shows the friction sleeve has a slit defined longitudinally therethrough;

FIG. 6 shows the friction sleeve has an end mounted to the handle;

FIG. 7 is a perspective view to show the friction sleeve has a stop flange;

FIG. 8 shows that the smoother is hung on a ridge of a bucket;

FIG. 9 is a top view to show a conventional smoother is held by a hand, and

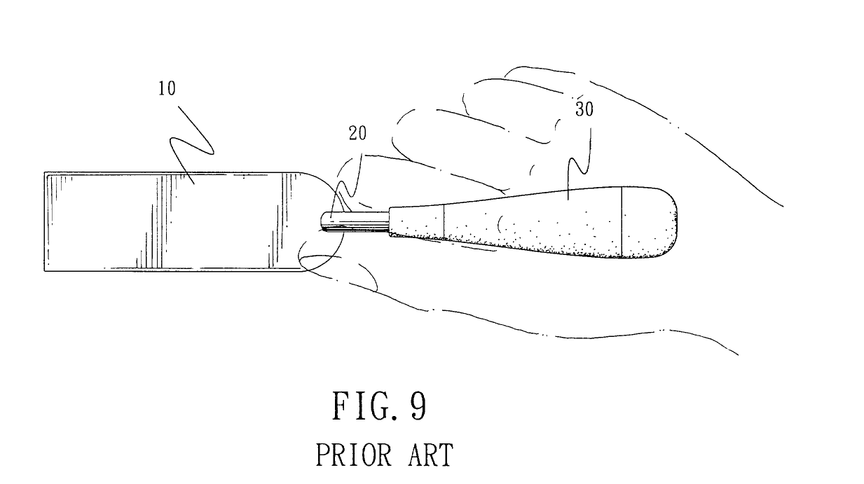

FIG. 10 is a perspective view to show the conventional smoother is held by a hand.

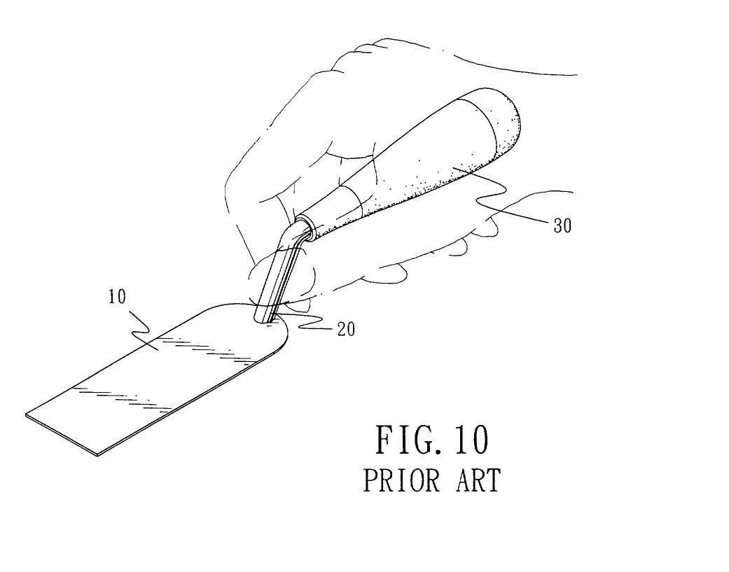

### DETAILED DESCRIPTION OF THE PREFERRED EMBODIMENT

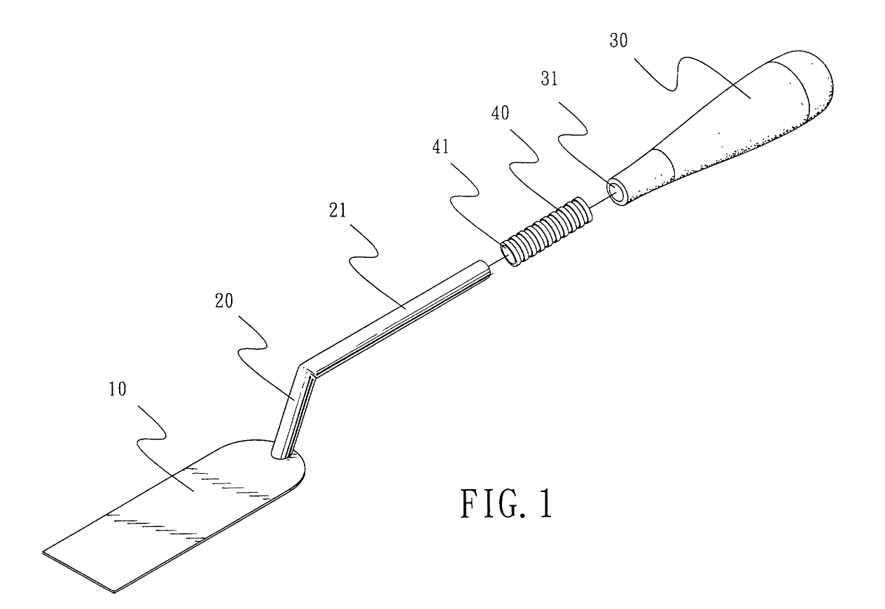

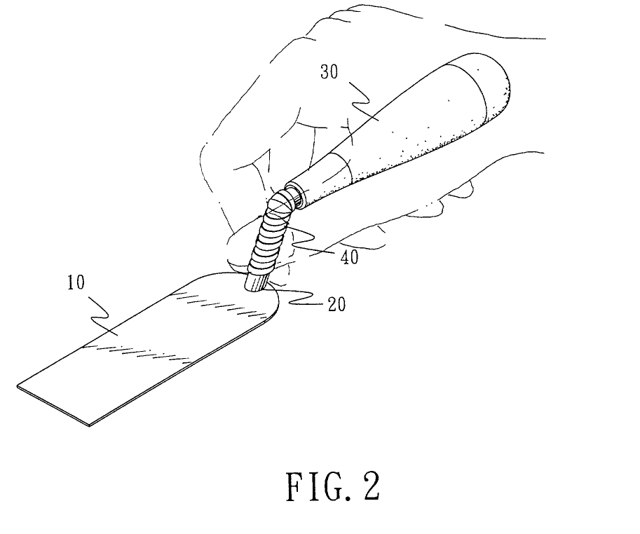

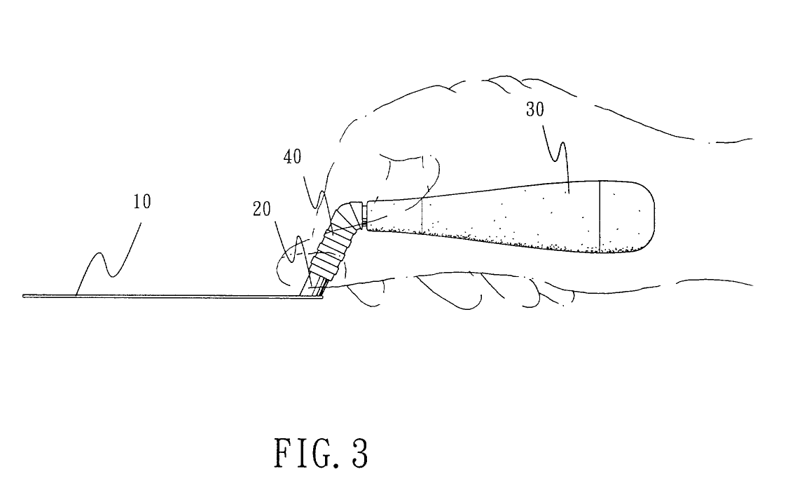

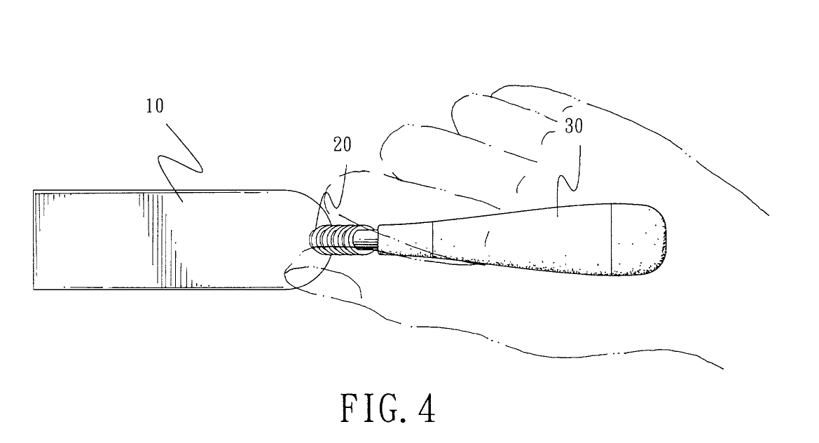

Referring to FIGS. 1 to 4 and 5, the smoother of the present invention comprises a plate 10 with an L-shaped neck 20 connected to an end of the plate 10. A handle 30 having an opening 31 which mounted to the neck 20. The neck 20 includes an insertion section 21 which is inserted in a central passage 41 defined longitudinally through a friction sleeve 40. The friction sleeve 40 is made of resilient material and has a rough outer surface so as to provide suitable friction when the user's index finger and thumb are holding the friction sleeve 40. The outer surface of the friction sleeve 40 can be made in various configuration and feature as long as it provides comfortable grasp and is not slippery.

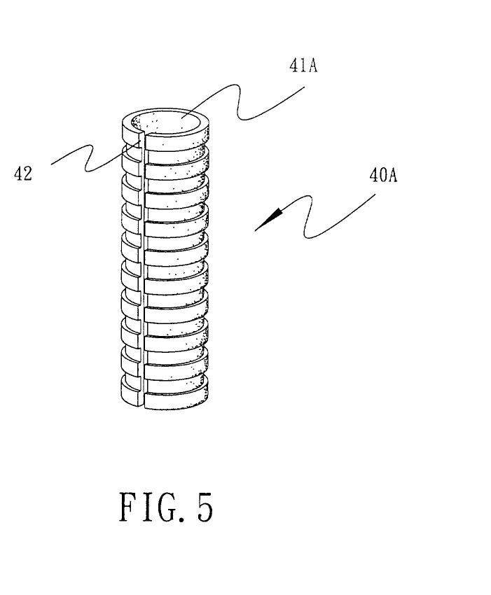

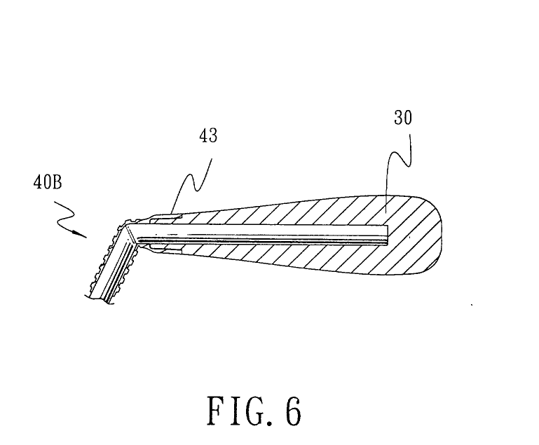

FIG. 5 shows that the friction sleeve 40A may have a slit 42 defined longitudinally therethrough and a central passage 41A. FIG. 6 shows that the friction sleeve 40B may have an engaging end 43 which is mounted to an end of the handle 30.

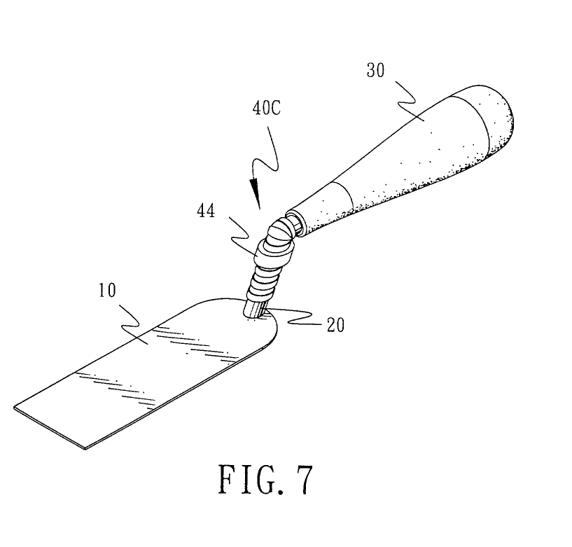

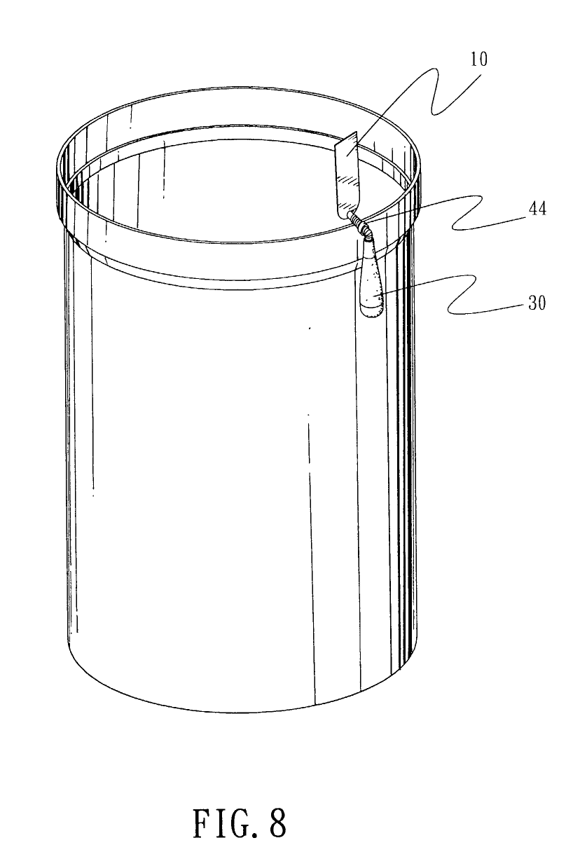

FIGS. 7 and 8 show that the friction sleeve 40C may have a stop flange 44 extending radially outward from the friction sleeve 40 and the stop flange 44 can be used to allow the smoother to be hung on a ridge of the opening of a bucket. By this way, when the smoother is not in use, the smoother can be hung on the bucket and needs not to be put on the ground.

While we have shown and described the embodiment in accordance with the present invention, it should be clear to those skilled in the art that further embodiments may be made without departing from the scope of the present invention.

What is claimed is:

1. A smoother comprising:
a plate with a neck connected to an end of the plate, a handle connected to the neck, and
a friction sleeve mounted to the neck.

2. The smoother as claimed in claim 1, wherein the friction sleeve has a central passage defined therethrough.

3. The smoother as claimed in claim 1, wherein the friction sleeve has a slit defined longitudinally therethrough.

4. The smoother as claimed in claim 1, wherein the friction sleeve has an engaging end which is mounted to an end of the handle.

5. The smoother as claimed in claim 1 further comprising a stop flange extending radially outward from the friction sleeve.
